(19) United States
(12) Patent Application Publication
(10) Pub. No.: US 2026/0179840 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventors: Chan Young Kim, Suwon-si (KR); Byung Woo Han, Suwon-si (KR); Sang Hyuk Lee, Suwon-si (KR); Hyun Bae Jang, Suwon-si (KR)

(73) Assignee: SAMSUNG ELECTRO-MECHANICS CO., LTD., Suwon-si (KR)

(21) Appl. No.: 19/361,701

(22) Filed: Oct. 17, 2025

(30) Foreign Application Priority Data
Dec. 20, 2024 (KR) 10-2024-0192973

(51) Int. Cl. H01G 4/12; H01G 4/012; H01G 4/30

(52) U.S. Cl. CPC H01G 4/1227; H01G 4/012; H01G 4/30

(57) ABSTRACT

A multilayer electronic component includes a body including a dielectric layer and an internal electrode alternately disposed with the dielectric layer, and an external electrode disposed on the body. The dielectric layer includes a central portion spaced apart from the internal electrode, and an interface portion disposed between the internal electrode and the central portion, the interface portion including Dy, Tb, and Gd. The central portion has an atomic percentage of a Tb content, lower than an atomic percentage of a Tb content of the interface portion, or substantially does not include Tb.

### CROSS-REFERENCE TO RELATED APPLICATION(S)

This application claims benefit of priority to Korean Patent Application No. 10-2024-0192973 filed on Dec. 20, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

An MLCC may be used as a component of various electronic devices due to having a small size, ensuring high capacitance and being easily mounted. With the miniaturization and high-output power of various electronic devices such as computers and mobile devices, demand for miniaturization and implementation of high capacitance of multilayer ceramic capacitors has also been increasing.

In addition, with the diverse usage environments of MLCCs, reliability at high temperatures has also been required.

In order to achieve miniaturization and high capacitance of MLCCs, it may be necessary to reduce a thickness of a dielectric layer and increase the number of layers. However, as the thickness of the dielectric layer decreases, physical defects may be more likely to occur, such that a process defect rate may be increased or reliability may be reduced. In addition, when Tb is added to the dielectric layer, it may be easy to ensure high-temperature reliability. However, a ceramic green sheet to which Tb is added may have reduced rigidity, such that a process defect rate may be increased, or structural defects may occur in the dielectric layer.

Accordingly, there is a demand for the development of an MLCC having a novel structure capable of ensuring high-temperature reliability while reducing thickness of a dielectric layer.

### SUMMARY

An aspect of the present disclosure is to provide a multilayer electronic component having excellent reliability.

Another aspect of the present disclosure is to provide a multilayer electronic component having excellent high-temperature reliability.

Another aspect of the present disclosure is to provide a multilayer electronic component including a dielectric layer having excellent rigidity.

However, the aspects of the present disclosure are not limited to those set forth herein, and will be more easily understood in the course of describing specific example embodiments of the present disclosure.

According to an aspect of the present disclosure, there is provided a multilayer electronic component including a body including a dielectric layer and internal electrodes alternately disposed with the dielectric layer, and an external electrode disposed on the body. The dielectric layer may include a central portion spaced apart from adjacent internal electrodes among the internal electrodes, and an interface portion disposed between the central portion and an internal electrode among the adjacent internal electrodes, the interface portion including Dy, Tb, and Gd. The central portion may have a Tb content, in atomic percentage, that is lower than a Tb content, in atomic percentage, of the interface portion, or the central portion may be substantially free of Tb.

According to another aspect of the present disclosure, a method of manufacturing a multilayer electronic component includes coating a sol solution on a film to form a first coating layer, the sol solution including Tb, Dy, and Gd, coating a slurry on the first coating layer to form a ceramic portion, the slurry including ceramic powder particles, coating the sol solution on the ceramic portion to form a second coating layer, and applying a paste to the second coating layer to form a ceramic green sheet, the paste including metal powder particles.

According to example embodiments of the present disclosure, Dy, Tb, and Gd may be disposed in an interface portion of a dielectric layer, and an atomic percentage of a Tb content of the interface portion may be controlled to be higher than an atomic percentage of a Tb content of a central portion of the dielectric layer, such that a multilayer electronic component may have improved reliability

However, the various advantages and effects of the present disclosure are not limited to those set forth herein, and will be more easily understood in the course of describing specific example embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 illustrates the example embodiment of FIG. 1 from which an external electrode is excluded;

FIG. 3 illustrates the example embodiment of FIG. 2 from which a side margin portion is excluded;

FIG. 4 is a schematic cross-sectional view taken along line I-I′ of FIG. 1;

FIG. 5 is a schematic cross-sectional view taken along line II-II′ of FIG. 1;

FIG. 6 is an enlarged view of region “K1” of FIG. 5;

FIG. 7 is an enlarged view of region “K2” of FIG. 5;

FIG. 8 is a diagram illustrating a process of manufacturing a ceramic green sheet for capacitance formation portion formation used in a method of manufacturing a multilayer electronic component according to an example embodiment of the present disclosure;

FIG. 9 is a diagram illustrating a process of forming a laminate in a method of manufacturing a multilayer electronic component according to an example embodiment of the present disclosure;

FIG. 10 is a graph illustrating results of performing a highly accelerated life test (HALT) on 40 sample chips of Test No. 4;

FIG. 11 is a graph illustrating results of performing a highly accelerated life test (HALT) on 40 sample chips of Test No. 5;

FIG. 12 is a graph illustrating results of performing a highly accelerated life test (HALT) on 40 sample chips of Test No. 6; and

FIG. 13 is a graph illustrating results of measuring breakdown voltages (BDV) of 20 sample chips of each of Test Nos. 4, 5, and 6.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, an X-direction may be defined as a first direction, a lamination direction, or a thickness (T) direction, a Y-direction may be defined as a second direction or a length (L) direction, and a Z-direction may be defined as a third direction or a width (W) direction.

### Multilayer Electronic Component

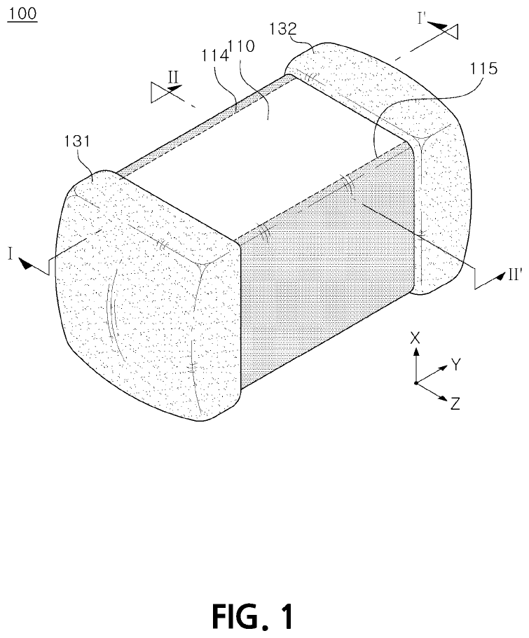

FIG. 1 is a schematic perspective view of a multilayer electronic component according to an example embodiment of the present disclosure.

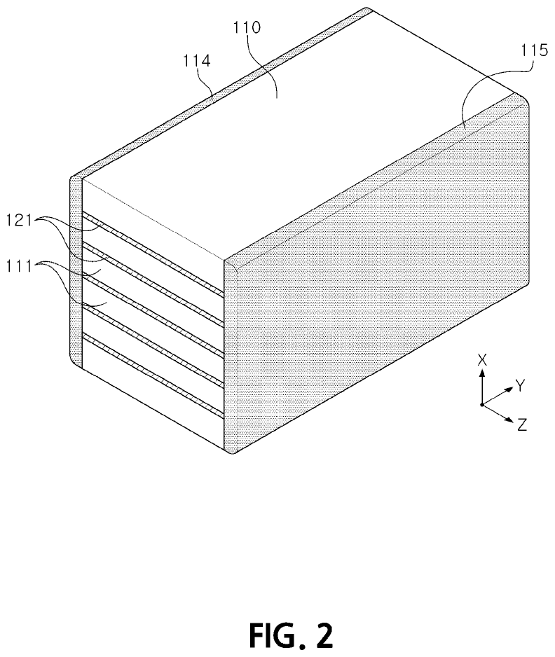

FIG. 2 illustrates the example embodiment of FIG. 1 from which an external electrode is excluded.

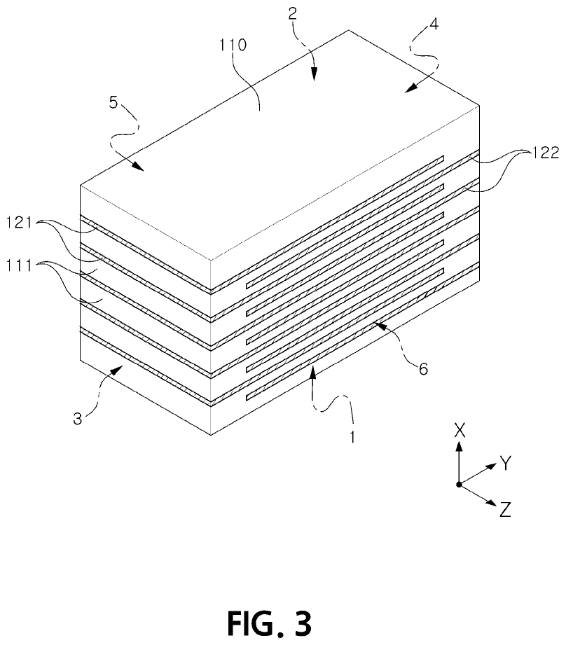

FIG. 3 illustrates the example embodiment of FIG. 2 from which a side margin portion is excluded.

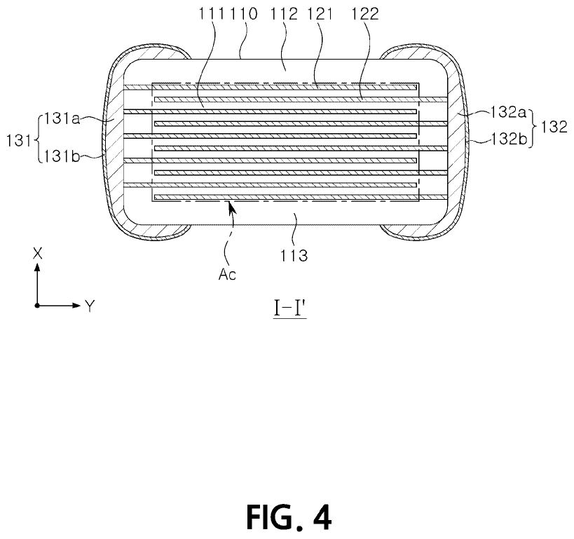

FIG. 4 is a schematic cross-sectional view taken along line I-I′ of FIG. 1.

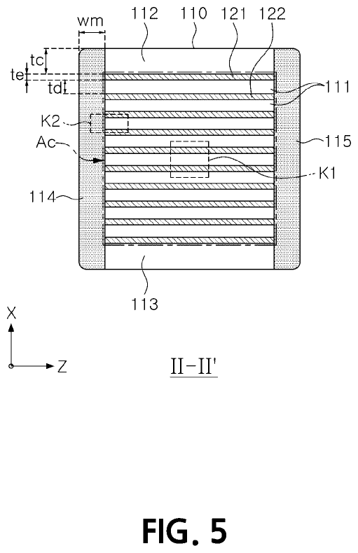

FIG. 5 is a schematic cross-sectional view taken along line II-II′ of FIG. 1.

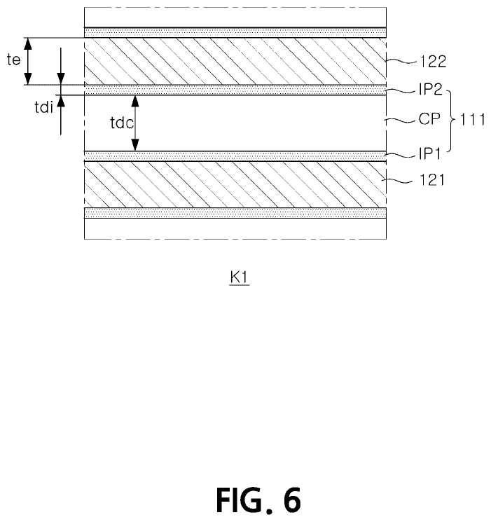

FIG. 6 is an enlarged view of region “K1” of FIG. 5.

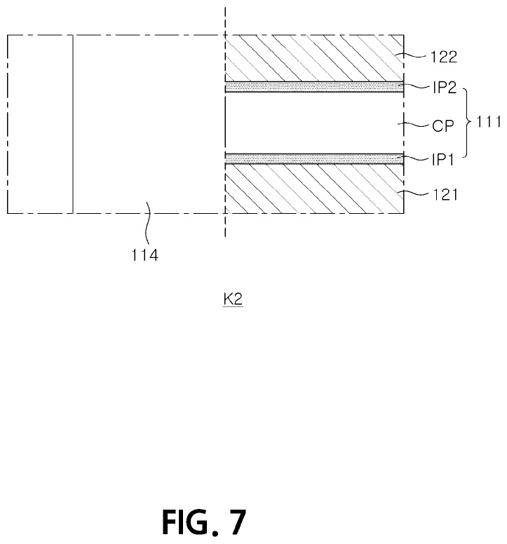

FIG. 7 is an enlarged view of region “K2” of FIG. 5.

Hereinafter, a multilayer electronic component 100 according to an example embodiment of the present disclosure will be described in detail with reference to FIGS. 1 to 7. In addition, a multilayer ceramic capacitor (hereinafter referred to as “MLCC”) is described as an example of the multilayer electronic component, but the present disclosure is not limited thereto, and may be applied to various electronic products formed of a ceramic material, such as inductors, piezoelectric elements, varistors, thermistors, or the like.

A multilayer electronic component 100 according to an example embodiment of the present disclosure may include a body 110 including a dielectric layer 111 and internal electrodes 121 and 121 alternately disposed with the dielectric layer, and external electrodes 131 and 132 disposed on the body. The dielectric layer 111 may include a central portion CP spaced apart from the internal electrodes, and interface portions IP1 and IP2 disposed between the internal electrodes and the central portion, the interface portions IP1 and IP2 including Dy, Tb, and Gd. The central portion CP may have an atomic percentage of a Tb content, lower than an atomic percentage of a Tb content of each of the interface portions IP1 and IP2, or may not substantially include Tb. As used herein, the expressions “not substantially include” and “substantially free of” may refer to a Tb content that is (i) 0.05 at % or less as measured by the methods described in the present disclosure or any other methods appreciated by one of ordinary skill in the art, or (ii) less than the detection limit of the tools used in the methods described in the present disclosure or any other methods appreciated by one of ordinary skill in the art.

To achieve miniaturization and high capacitance of an MLCC, it may be necessary to reduce thickness of a dielectric layer and increase the number of layers. However, as a thickness of the dielectric layer decreases, physical defects may be more likely to occur, such that a process defect rate may be increased or reliability may be reduced. In addition, when Tb is added to the dielectric layer, it may be easy to ensure high-temperature reliability. However, a ceramic green sheet to which Tb is added may have reduced rigidity, such that a process defect rate may be increased, or structural defects may occur in the dielectric layer. Here, rigidity may refer to a property of being hard or stiff such that shape or volume does not change even when pressure is applied from outside.

According to an example embodiment of the present disclosure, when Dy, Tb, and Gd are disposed in the interface portions IP1 and IP2 of the dielectric layer 111, and an atomic percentage of a Tb content of each of the interface portions IP1 and IP2 is controlled to be higher than an atomic percentage of a Tb content of the central portion CP, the occurrence of physical and structural defects in the dielectric layer may be suppressed, and the multilayer electronic component 100 may have improved high-temperature reliability.

Hereinafter, each of components included in the multilayer electronic component 100 according to an example embodiment of the present disclosure will be described.

In the body 110, the dielectric layer 111 and the internal electrodes 121 and 122 may be alternately laminated.

A specific shape of the body 110 is not limited. However, as illustrated, the body 110 may have a hexahedral shape or a shape similar thereto. During a sintering process, ceramic powder particles, included in the body 110, may shrink, such that the body 110 may not have a hexahedral shape having perfectly straight lines, but may have a substantially hexahedral shape.

The body 110 may have first and second surfaces 1 and 2 opposing each other in the first direction, third and fourth surfaces 3 and 4 connected to the first and second surfaces 1 and 2, the third and fourth surfaces 3 and 4 opposing each other in a second direction, and fifth and sixth surfaces 5 and 6 connected to the third and fourth surfaces 3 and 4, the fifth and sixth surfaces 5 and 6 opposing each other in a third direction.

As margin regions in which the internal electrodes 121 and 122 are not disposed on the dielectric layer 111 overlap each other, a step portion may be caused by thicknesses of the internal electrodes 121 and 122, such that a corner, connecting the first surface and the third to fifth surfaces to each other, and/or a corner, connecting the second surface and the third to fifth surfaces to each other, may shrink toward a central portion in the first direction of the body 110 relative to the first surface or the second surface. Alternatively, due to shrinkage behavior of the body during a sintering process, a corner, connecting the first surface 1 and the third to sixth surfaces 3, 4, 5, and 6 to each other, and/or a corner, connecting the second surface 2 and the third to sixth surfaces 3, 4, 5, and 6 to each other, may shrink toward the central portion in the first direction of the body 110 relative to the first surface or the second surface. Alternatively, in order to prevent chipping defects or the like, an additional process may be performed to round corners connecting respective surfaces of the body 110 to each other. Accordingly, a corner, connecting the first surface and third to sixth surfaces to each other, and/or a corner, connecting the second surface and the third to sixth surfaces to each other, may have a round shape.

In order to suppress a step portion caused by the internal electrodes 121 and 122, internal electrodes may be laminated and then cut to be exposed to the fifth and sixth surfaces 5 and 6 of the body. Thereafter, one dielectric layer or two or more dielectric layers may be laminated on both side surfaces of a capacitance formation portion Ac in the third direction (width direction) to form side margin portions 114 and 115. In this case, a portion, connecting a first surface and fifth and sixth surfaces to each other, and a portion, connecting a second surface and the fifth and sixth surfaces to each other, may not shrink.

A plurality of dielectric layers 111, included in the body 110, may be in a sintered state, and adjacent dielectric layers 111 may be integrated with each other such that boundaries therebetween are not readily apparent without using a scanning electron microscope (SEM). The number of laminated dielectric layers is not limited, and may be determined in consideration of a size of the multilayer electronic component. For example, the body may be formed by laminating 400 or more dielectric layers.

Dy, Tb, and Gd may be disposed in the interface portions IP1 and IP2 of the dielectric layer 111. In general, in order to improve reliability, a predetermined amount of a rare-earth element may be added to a dielectric layer. The interface portions IP1 and IP2, disposed at interfaces with the internal electrodes 121 and 122, rather than the central portion CP of the dielectric layer 111, may have the greatest influence on reliability of the multilayer electronic component. Accordingly, in the present disclosure, Dy, Tb, and Gd may be disposed in the interface portions IP1 and IP2 of the dielectric layer 111 to effectively improve withstand voltage and reliability.

In addition, an atomic percentage of a Tb content of each of the interface portions IP1 and IP2 may be controlled to be higher than an atomic percentage of a Tb content of the central portion CP, the occurrence of physical and structural defects may be suppressed in the dielectric layer 111, and the multilayer electronic component 100 may have improved high-temperature reliability. When the central portion CP has a high Tb content, the dielectric layer 111 may have reduced rigidity, resulting in brittle characteristics. As a result, structural defects may occur in the dielectric layer 111.

In addition, Dy, Tb, and Gd may be disposed in the interface portions IP1 and IP2 of the dielectric layer 111, and accordingly disconnection and aggregation of the internal electrode may be suppressed, thereby improving reliability and capacitance per unit volume of the multilayer electronic component.

In an example embodiment, the dielectric layer 111 may have a sum of Dy, Tb, and Gd contents of 1.5 mol or less relative to 100 mol of Ti. Accordingly, TCC temperature characteristics (X6S) may be satisfied while withstand voltage characteristics are improved.

When the sum of the Dy, Tb, and Gd contents in the dielectric layer 111 is greater than 1.5 mol relative to 100 mol of Ti, a Curie temperature (Tc) may shift to room temperature, and thus the TCC temperature characteristics (X6S) may not be satisfied.

In an example embodiment, the Tb content of the dielectric layer 111 may be 0.5 mol or less relative to 100 mol of Ti. When the Tb content included in the dielectric layer 111 is greater than 0.5 mol relative to 100 mol of Ti, the dielectric layer 111 may have reduced rigidity, resulting in brittle characteristics. As a result, structural defects may occur in the dielectric layer 111.

A lower limit of the Tb content included in the dielectric layer 111 is not limited. For example, the lower limit of the Tb content included in the dielectric layer 111 may be 0.2 mol or more relative to 100 mol of Ti. Accordingly, the multilayer electronic component 100 may have further improved reliability.

In an example embodiment, the dielectric layer 111 may have a molar ratio of a Gd content to a sum of Dy and Tb contents of 0.2 or more and 0.67 or less. Accordingly, a reliability improvement effect due to addition of Gd may become significant.

When the molar ratio of the Gd content to the sum of Dy and Tb contents is less than 0.2, the reliability improvement effect due to addition of Gd may be insufficient. When the molar ratio is greater than 0.67, the dielectric layer 111 may become excessively N-type, and product characteristics may be degraded.

A lower limit of the molar ratio of the Gd content to the sum of Dy and Tb contents may be preferably 0.2 or more, and more preferably 0.200 or more.

Lower limits of the Dy content and the Tb content are not limited. For example, the dielectric layer 111 may have a Dy content of 0.2 mol or more relative to 100 mol of Ti, and may have a Tb content of 0.2 mol or more relative to 100 mol of Ti.

In an example embodiment, when an atomic percentage of a Tb content of each of the interface portions IP1 and IP2 is referred to as At1 and an atomic percentage of a Tb content of the central portion CP is referred to as At2, At1/At2 may be 5 or more.

This may be because it is preferable that Tb is concentratedly distributed in the interface portions IP1 and IP2 of the dielectric layer 111 to improve reliability and is substantially excluded from the central portion CP to suppress a decrease in rigidity of the dielectric layer 111.

In this case, an atomic percentage (At1) of a Tb content of each of the interface portions IP1 and IP2 may preferably be 0.2 at % or more and 0.5 at % or less, and an atomic percentage (At2) of a Tb content of the central portion CP may preferably be 0.1 at % or less.

Elemental analysis of the dielectric layer 111 may be performed based on an image obtained by observing a cross-section in the first and second directions of the body 110 using a scanning electron microscope-energy dispersive X-ray spectrometer (SEM-EDS), a transmission electron microscope-energy dispersive X-ray spectrometer (TEM-EDS), a scanning transmission electron microscope-energy dispersive X-ray spectrometer (STEM-EDS), or a field emission-scanning electron microscope-energy dispersive X-ray spectrometer (FE-SEM-EDS). Other methods and/or tools appreciated by one of ordinary skill in the art, even if not described in the present disclosure, may also be used.

More specifically, the cross-section in the first and second directions of the multilayer electronic component 100 may be exposed by polishing the multilayer electronic component 100 up to ½ point in the third direction of the multilayer electronic component 100. Thereafter, contents (mol %) of Ti, Dy, Tb and Gd may be measured in a dielectric layer disposed in a central portion in the first direction of the capacitance formation portion Ac using an FE-SEM-EDS (acceleration voltage: 2 kV, magnification: 50,000 times). Based on the measurement results, the number of moles of Dy, Tb and Gd may be calculated relative to 100 moles of Ti included in the dielectric layer. 10 dielectric layers respectively disposed in an upper portion, a central portion, and a lower portion in the first direction of the capacitance formation portion Ac may be selected, and the number of moles of Dy, Tb and Gd may be calculated relative to 100 moles of Ti for each of a total of 30 dielectric layers. Then, an average value of the calculated values may be obtained to enable further generalization.

The interface portion IP and the central portion CP of the dielectric layer 111 may be distinguished from each other in an image illustrating a concentration of each element, and such distinct may be based on a Tb content. Thereafter, an atomic percentage of a Tb content measured in a center in the first direction of the interface portion IP may be referred to as At1, and an atomic percentage of a Tb content measured in a center in the first direction of the central portion CP may be referred to as At2. 10 dielectric layers respectively disposed in an upper portion, a central portion, and a lower portion in the first direction of the capacitance formation portion Ac may be selected, and At1 and At2 may be obtained for each of a total of 30 dielectric layers, and an average value of the obtained values may be obtained to enable further generalization.

In an example embodiment, an average thickness (tdi) of the interface portion may be 10 nm or more and 50 nm or less.

When the average thickness (tdi) of the interface portion is less than 10 nm, a reliability improvement effect due to the interface portion may be insufficient. When the average thickness (tdi) of the interface portion is greater than 50 nm, a thickness of the dielectric layer may be increased.

The average thickness (tdi) of the interface portion may refer to a thickness of each of a first interface portion IP1 and a second interface portion IP2. That is, an average thickness of the first interface portion IP1 may be 10 nm or more and 50 nm or less, and an average thickness of the second interface portion IP2 may be 10 nm or more and 50 nm or less.

In an example embodiment, an average thickness (tdc) of the central portion CP may be 500 nm or less. Accordingly, the thickness of the dielectric layer 111 may be reduced, thereby more easily achieving miniaturization and high capacitance of the multilayer electronic component.

In an example embodiment, when the average thickness of the central portion is referred to as td and the average thickness of the interface portion is referred to as tcl, tcl/td may be 0.02 or more and 0.1 or less.

An average thickness (td) of the dielectric layer 111 is not limited. For example, the dielectric layer 111, disposed between the internal electrodes 121 and 122, may include the central portion CP, the first interface portion IP1, and the second interface portion IP2, and thus may be 600 nm or less.

Here, the average thickness (tdi) of the interface portion and the average thickness (tdc) of the central portion may refer to thicknesses in the first direction. The average thickness (tdi) of the interface portion and the average thickness (tdc) of the central portion may be measured by scanning, with an SEM, a cross-section in the first and second directions of the body 110 at a magnification of 10,000. More specifically, after the interface portion including Dy, Tb and Gd is identified using an SEM-EDS, the thicknesses of the interface portion IP1 and the central portion CP may be measured at 30 points spaced apart from each other at equal intervals in the second direction, and respective average values thereof may be measured. The 30 points, spaced apart from each other at equal intervals, may be designated in the capacitance formation portion Ac to be described below. In addition, when such average value measurement is performed on 10 dielectric layers 111, the average thickness (tdi) of the interface portion and the average thickness (tdc) of the central portion may be further generalized. Other methods and/or tools appreciated by one of ordinary skill in the art, even if not described in the present disclosure, may also be used.

A method of forming the dielectric layer 111 is not limited.

For example, a sol solution including Tb, Dy, and Gd may first be coated on a carrier film 300 to form a first coating layer PIP1. Thereafter, a ceramic slurry including ceramic powder particles, an organic solvent, and a binder may be coated on the first coating layer PIP1 to form a ceramic portion PCP. Thereafter, a ceramic green sheet in which a second coating layer PIP2 is formed by coating a sol solution including Tb, Dy, and Gd on the ceramic portion PCP, may be prepared, and then the ceramic green sheet may be sintered. In the sintering process, Tb, Dy, and Gd included in the first and second coating layers PIP1 and PIP2 may react with a portion of the ceramic portion PCP to form the interface portions IP1 and IP2, and a region excluding the interface portions IP1 and IP2 may become the central portion CP.

When the ceramic green sheet is formed as an ultrathin layer, structural defects such as an increase in surface roughness and thickness unevenness of the ceramic green sheet may occur. According to an example embodiment of the present disclosure, when first and second coating layers PIP1 and PIP2 are formed on both surfaces of the ceramic portion CPC, structural defects of the ceramic green sheet may be compensated for, thereby improving reliability.

In addition, when Tb, Dy, and Gd are directly mixed into a ceramic slurry including ceramic powder particles, an organic solvent, and a binder, and a ceramic green sheet may be manufactured using the resulting slurry, the ceramic green sheet may have increased rigidity, such that a process defect rate may be increased, or structural defects may occur in the dielectric layer.

According to an example embodiment of the present disclosure, when first and second coating layers PIP1 and PIP2 are formed on both surfaces of the ceramic portion CPC, structural defects of the ceramic green sheet may be compensated for, thereby improving reliability.

The ceramic powder particles, included in the ceramic green sheet, are not limited as long as sufficient capacitance is obtainable therewith, and may be, for example, barium titanate-based (BaTiO₃)-based powder particles. As a more specific example, the ceramic powder particles may be at least one of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), and Ba(Ti_{1-y}Zr_{y})O₃ (0<y<1).

Accordingly, in an example embodiment, the dielectric layer 111 may include, as a main element, at least one BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), and Ba(Ti_{1-y}Zr_{y})O₃ (0<y<1). Here, the main element may mean that the number of moles of elements excluding the main element is 30 mol or less relative to 100 mol of the main element.

The body 110 may include a capacitance formation portion Ac disposed in the body 110, the capacitance formation portion Ac having capacitance by including the first internal electrode 121 and the second internal electrode 122 disposed to oppose each other with the dielectric layer 111 interposed therebetween, and cover portions 112 and 113 disposed on upper and lower portions in the first direction of the capacitance formation portion Ac.

In addition, the capacitance formation portion Ac may be a portion contributing to forming capacitance of a capacitor, and may be formed by repeatedly laminating a plurality of first and second internal electrodes 121 and 122 on each other with the dielectric layer 111 interposed therebetween.

The cover portions 112 and 113 may include an upper cover portion 112 disposed on the upper portion in the first direction of the capacitance formation portion Ac, and a lower cover portion 113 disposed on the lower portion in the first direction of the capacitance formation portion Ac.

The upper cover portion 112 and the lower cover portion 113 may be respectively formed by laminating one dielectric layer or two or more dielectric layers on upper and lower surfaces of the capacitance formation portion Ac in a thickness direction, and may basically serve to prevent the internal electrode from being damaged due to physical or chemical stress.

The upper cover portion 112 and the lower cover portion 113 may not include the internal electrode, and may include a material the same as that of the dielectric layer 111.

That is, the upper cover portion 112 and the lower cover portion 113 may include a ceramic material, and may include, for example, a barium titanate (BaTiO₃)-based ceramic material.

A thickness of each of the cover portions 112 and 113 is not limited. However, in order to easily achieve miniaturization and high capacitance of the multilayer electronic component, a thickness (tc) of each of the cover portions 112 and 113 may be 15 μm or less.

An average thickness (tc) of each of the cover portions 112 and 113 may refer to a size in the first direction of each of the cover portions 112 and 113, and may have a value obtained by averaging sizes in the first direction of each of the cover portions 112 and 113, measured at five points spaced apart from each other at equal intervals of an upper portion or lower portion of the capacitance formation portion Ac.

In addition, the margin portions 114 and 115 may be disposed on side surfaces of the capacitance formation portion Ac, respectively.

The margin portions 114 and 115 may include a first margin portion 114 disposed on the fifth surface 5 of the body 110 and a second margin portion 115 disposed on the sixth surface 6 of the body 110. That is, the margin portions 114 and 115 may be disposed on both end surfaces in a width direction of the ceramic body 110, respectively.

As illustrated in FIG. 5, the margin portions 114 and 115 may refer to regions between both ends of each of the first and second internal electrodes 121 and 122 and an interface of the body 110 in a cross-section of the body 110 cut in a width-thickness (W-T) direction.

The margin portions 114 and 115 may basically serve to prevent the internal electrode from being damaged due to physical or chemical stress.

The margin portions 114 and 115 may be formed by forming the internal electrode by coating a conductive paste on a ceramic green sheet, except for a portion of the ceramic green sheet on which a margin portion is to be formed.

In addition, in order to suppress a step portion caused by the internal electrodes 121 and 122, the internal electrodes may be laminated and then cut to be exposed to the fifth and sixth surfaces 5 and 6 of the body. Thereafter, one dielectric layer or two or more dielectric layers may be laminated on both side surfaces of the capacitance formation portion Ac in the third direction (width direction) to form the margin portions 114 and 115.

A width of each of the margin portions 114 and 115 is not limited. However, in order to easily achieve miniaturization and high capacitance of the multilayer electronic component, an average width of each of the margin portions 114 and 115 may be 15 μm or less.

The average width of each of the margin portions 114 and 115 may be an average size in the third direction (MW1) of a region in which the internal electrode is spaced apart from the fifth surface or an average size in the third direction (MW2) of a region in which the internal electrode is spaced apart from the sixth surface, and may have an average value of sizes in the third direction of each of the margin portions 114 and 115, measured at five points spaced apart from each other at equal intervals of a side surface of the capacitance formation portion Ac.

Accordingly, in an example embodiment, each of the average sizes in the third direction (MW1 and MW2) of regions in which the internal electrodes 121 and 122 are spaced apart from the fifth and sixth surfaces may be 15 μm or less.

In an example embodiment, the dielectric layer 111 and the internal electrodes 121 and 122 may be alternately laminated in the first direction. The body 110 may have a first surface 1 and a second surface 2 opposing each other in the first direction, a third surface 3 and a fourth surface 4 connected to the first and second surfaces, the third and fourth surfaces opposing each other in the second direction, and a fifth surface 5 and a sixth surface 6 connected to the first to fourth surfaces, the fifth and sixth surfaces opposing each other in the third direction. The external electrodes 131 and 132 may be disposed on the third and fourth surfaces, and the side margin portions 114 and 115 may be disposed on the fifth and sixth surfaces.

In this case, the interface portions IP1 and IP2 and the central portion CP may be led out to the third and fourth surfaces and connected to the external electrodes 131 and 132, and may be led out to the fifth and sixth surfaces and connected to the side margin portions 114 and 115.

Referring to FIG. 7, in order to suppress a step portion caused by the internal electrodes 121 and 122, the internal electrodes 121 and 122 may be cut to be exposed to the fifth and sixth surfaces 5 and 6 of the body. Thereafter, one dielectric layer or two or more dielectric layers may be laminated on both side surfaces of the capacitance formation portion Ac in the third direction (width direction) to form the margin portions 114 and 115. In this case, the interface portions IP1 and IP2 may not be disposed in the margin portions 114 and 115.

A method of forming the margin portions 114 and 115 by laminating one or more dielectric layers on both side surfaces of the capacitance formation portion Ac in the third direction (width direction) may be generally applied to miniaturized and high-capacitance products. Accordingly, a reliability improvement effect according to the present disclosure may become more significant. In particular, the internal electrodes 121 and 122 may need to be cut to be exposed to the fifth and sixth surfaces 5 and 6. When a ceramic green sheet for capacitance formation portion formation has insufficient rigidity, a process defect rate may be increased, or structural defects may occur in the dielectric layer. Accordingly, according to the example embodiment of the present disclosure, rigidity of the dielectric layer may be ensured. Thus, even when one or more dielectric layers are laminated on both side surfaces of the capacitance formation portion Ac in the third direction (width direction) to form the margin portions 114 and 115, an increase in the process defect rate or the occurrence of structural defects in the dielectric layer may be suppressed.

The internal electrodes 121 and 122 may include first and second internal electrodes 121 and 122. The first and second internal electrodes 121 and 122 may be alternately disposed to oppose each other with the dielectric layer 111, included in the body 110, interposed therebetween, and may be exposed to the third and fourth surfaces 3 and 4 of the body 110, respectively.

The first internal electrode 121 may be spaced apart from the fourth surface 4 and exposed through the third surface 3, and the second internal electrode 122 may be spaced apart from the third surface 3 and exposed through the fourth surface 4. The first external electrode 131 may be disposed on the third surface 3 of the body and connected to the first internal electrode 121, and the second external electrode 132 may be disposed on the fourth surface 4 of the body and connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance. In addition, the first and second internal electrodes 121 and 122 may be disposed to be spaced apart from the fifth and sixth surfaces of the body 110.

A conductive metal, included in the internal electrodes 121 and 122, may include at least one of Ni, Cu, Pd, Ag, Au, Pt, In, Sn, Al, W, Ti, and alloys thereof, but the present disclosure is not limited thereto.

An average thickness (the) of the internal electrode is not limited. In this case, a thickness of each of the internal electrodes 121 and 122 may refer to a size in the first direction of each of the internal electrodes 121 and 122.

However, in order to more easily achieve miniaturization and high capacitance of the multilayer electronic component, the average thickness of each of the internal electrodes 121 and 122 may be 0.4 μm or less.

Here, the average thickness (the) of the internal electrode may be measured by scanning, with an SEM, a cross-section of the body 110 in the first and second directions at a magnification of 10,000. More specifically, thicknesses of each of the internal electrodes 121 and 122 at multiple points, for example, thirty points spaced apart from each other at equal intervals in the second direction, may be measured to measure an average value thereof. The thirty points, spaced apart from each other at equal intervals, may be designated in the capacitance formation portion Ac. In addition, when such average value measurement is performed on ten internal electrodes 121 or ten internal electrodes 122, the average thickness of each of the internal electrodes 121 and 122 may be further generalized.

The external electrodes 131 and 132 may be disposed on the third and fourth surfaces 3 and 4 of the body 110, respectively.

The external electrodes 131 and 132 may be disposed on the third and fourth surfaces 3 and 4 of the body 110, respectively, and may include first and second external electrodes 131 and 132 respectively connected to the first and second internal electrodes 121 and 122.

Referring to FIG. 1, the external electrodes 131 and 132 may be disposed to cover both end surfaces in the second direction of the side margin portions 114 and 115.

In the present example embodiment, a structure in which the multilayer electronic component 100 has two external electrodes 131 and 132 is described, but the number and shape of the external electrodes 131 and 132 may be changed depending on the form of the internal electrodes 121 and 122 or other purposes.

Each of the external electrodes 131 and 132 may be formed of any material having electrical conductivity, such as a metal or the like, and a specific material may be determined in consideration of electrical characteristics, structural stability, or the like. In addition, each of the external electrodes 131 and 132 may have a multilayer structure.

For example, the external electrodes 131 and 132 may include electrode layers 131a and 132a disposed on the body 110, and plating layers 131b and 132b formed on the electrode layers 131a and 132a.

As a more specific example of the electrode layers 131a and 132a, the electrode layers 131a and 132a may be a sintered electrode including a conductive metal and glass, or a resin-based electrode including a conductive metal and resin.

In addition, the electrode layers 131a and 132a may have a form in which a sintered electrode and a resin-based electrode are sequentially formed on a body. In addition, the electrode layers 131a and 132a may be formed by transferring a sheet including a conductive metal onto the body or by transferring a sheet including a conductive metal onto the sintered electrode.

A material having excellent electrical conductivity may be used as the conductive metal included in the electrode layers 131a and 132a, but the material is not limited. For example, the conductive metal may be at least one of nickel (Ni), copper (Cu), and an alloy thereof.

The plating layers 131b and 132b may serve to improve mounting characteristics. A type of each of the plating layers 131b and 132b is not limited, and each of the plating layers 131b and 132b may be a plating layer including at least one of Ni, Sn, Pd, and alloys thereof, and may be formed of a plurality of layers.

As a more specific example of the plating layers 131b and 132b, each of the plating layers 131b and 132b may be a Ni plating layer or a Sn plating layer, may have a form in which a Ni plating layer and a Sn plating layer are sequentially formed on the electrode layers 131a and 132a, and may have a form in which a Sn plating layer, a Ni plating layer, and a Sn plating layer are sequentially formed. In addition, each of the plating layers 131b and 132b may include a plurality of Ni plating layers and/or a plurality of Sn plating layers.

A size of the multilayer electronic component 100 is not limited.

However, according to an example embodiment of the present disclosure, thicknesses of the internal electrode and the dielectric layer may be easily reduced, such that a reliability improvement effect and a capacitance per unit volume improvement effect according to the present disclosure may become more significant in a multilayer electronic component 100 having a size of 0603 (length× width: 0.6 mm×0.3 mm) or less. In addition, a structure of the present disclosure may also be applied to a multilayer electronic component 100 having a size of 0201 (length× width: 0.2 mm×0.1 mm) or less.

Considering a manufacturing error, an external electrode size, or the like, a reliability improvement effect and a capacitance per unit volume improvement effect according to the present disclosure may become more significant when the multilayer electronic component 100 has a length of 0.66 mm or less and a width of 0.33 mm or less. Here, a length of the multilayer electronic component 100 may refer to a maximum size in the second direction of the multilayer electronic component 100, and a width of the multilayer electronic component 100 may refer to a maximum size in the third direction of the multilayer electronic component 100.

### Method of Manufacturing Multilayer Electronic Component

Hereinafter, an example of a method for manufacturing the multilayer electronic component 100 according to an example embodiment of the present disclosure will be described. However, the method of manufacturing the multilayer electronic component 100 of the present disclosure is not limited thereto.

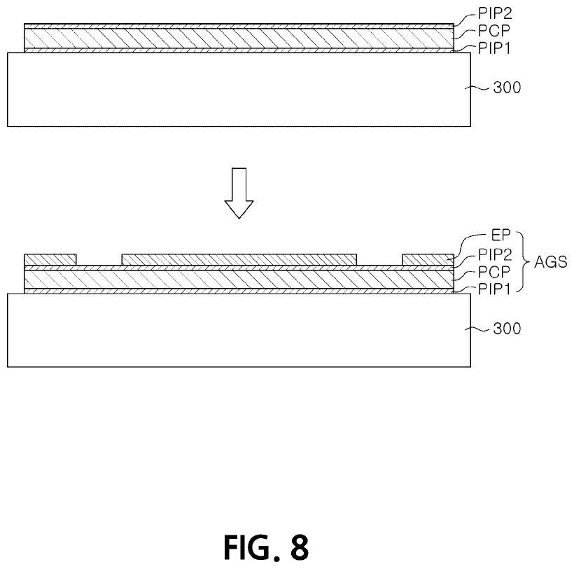

FIG. 8 is a diagram illustrating a process of manufacturing a ceramic green sheet for capacitance formation portion formation used in a method of manufacturing a multilayer electronic component according to an example embodiment of the present disclosure.

First, a sol solution including Tb, Dy, and Gd may be coated on a carrier film 300 to form a first coating layer PIP1. Thereafter, a ceramic slurry including ceramic powder particles, an organic solvent, and a binder may be coated on the first coating layer PIP1 to form a ceramic portion PCP. Thereafter, a sol solution including Tb, Dy, and Gd may be coated on the ceramic portion PCP to form a second coating layer PIP2.

Thereafter, an internal electrode conductive paste including metal powder particles, a binder, and an organic solvent may be printed on the second coating layer PIP2 to a predetermined thickness using a screen-printing method or a gravure-printing method, thereby manufacturing a ceramic green sheet AGS for capacitance formation portion formation.

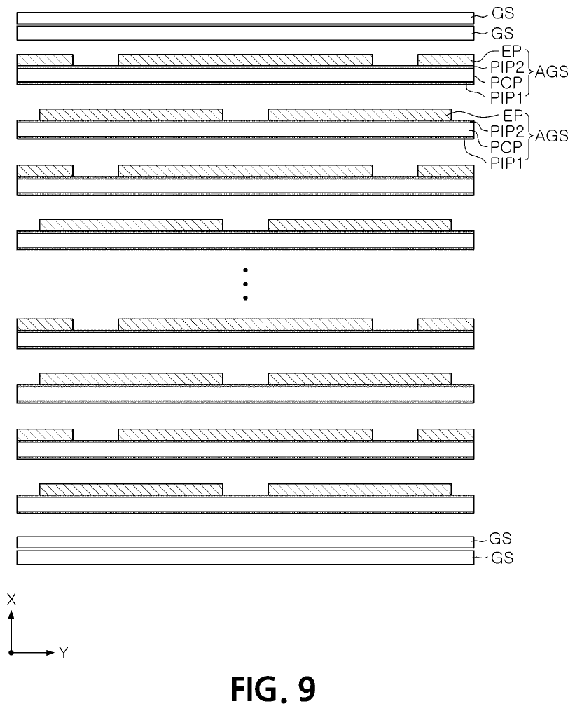

FIG. 9 is a diagram illustrating a process of forming a laminate in a method of manufacturing a multilayer electronic component according to an example embodiment of the present disclosure.

Ceramic green sheets AGS for capacitance formation portion formation may be laminated in an X-direction to form a laminate. In this case, general ceramic green sheets may be laminated on upper and lower portions of the laminate to form cover portions 112 and 113 after sintering. Here, the general ceramic green sheet may refer to a ceramic green sheet including a ceramic portion PCP without the above-described first and second coating layers PIP1 and PIP2.

Thereafter, the laminate may be cut to have a predetermined chip size. In this case, an end of an internal electrode pattern may be exposed to both surfaces of the cut chip opposing each other in a third direction.

Subsequently, a sheet for margin portion formation may be attached to both surfaces in the third direction of the cut chip, and then sintered to form a body 110 and side margin portions 114 and 115. A sintering temperature may be, for example, 1000° C. or higher and 1400° C. or lower, but the present disclosure is not limited thereto.

The sheet for margin portion formation is not limited, and may be the above-described general ceramic green sheet.

Subsequently, external electrodes 131 and 132 may be formed. For example, when base electrode layers 131a and 132a include a sintered electrode layer, the body 110 may be dipped into an external electrode conductive paste including metal powder particles, glass frit, a binder, and an organic solvent, and then the external electrode conductive paste may be sintered at a temperature of 500° C. to 900° C. to form the sintered electrode layer.

For example, when the base electrode layers 131a and 132a include a resin electrode layer, the body may be dipped into a conductive resin composition including metal powder particles, resin, a binder, and an organic solvent, and then cured by heat treatment at a temperature of 250° C. to 550° C. to form the resin electrode layer.

In addition, plating layers 131b and 132b may be formed on the base electrode layers 131a and 132a by further performing an electrolytic plating method and/or an electroless plating method.

### EXPERIMENTAL EXAMPLES

Sample chips having a size of 0603 (length: about 0.6 mm, width: about 0.3 mm, thickness: about 0.3 mm) were prepared using the manufacturing method described above.

Tb, Dy, and Gd were not added to the ceramic portion PCP, but were added only to a sol solution for forming coating layers PIP1 and PIP2. The number of moles of Tb, Dy, and Gd relative to 100 mol of Ti included in the dielectric layer 111 was adjusted to satisfy Tables 1 and 3 below.

The number of moles of Tb, Dy, and Gd relative to 100 mol of Ti included in the dielectric layer 111 was measured by analyzing a cross-section in the first and second directions of a sample chip, which was polished up to a ½ point in the third direction, using an FE-SEM-EDS (acceleration voltage: 2 kV, magnification: 50,000 times).

In addition, temperature characteristics of Test Nos. 1, 2, and 3 were evaluated, and evaluation results are indicated in Table 2 below. In Table 2, for each test number, a capacitance change rate (%) from −55° C. to 105° C. is indicated relative to a capacitance measured at 25° C. for a corresponding sample chip.

In order to satisfy X6S temperature characteristics, the capacitance change rate (%) from −55° C. to 105° C. may need to be +22% or less.

TABLE 1

| Test No. | Dy | Tb | Gd | Dy + Tb + Gd |
|---|---|---|---|---|
| 1 | 0.75 | 0.5 | 0.25 | 1.5 |
| 2* | 0.88 | 0.58 | 0.29 | 1.75 |
| 3* | 1 | 0.67 | 0.33 | 2 |

TABLE 2

| | Test No. | | |
|---|---|---|---|
| Temperature | 1 | 2 | 3 |
| (° C.) | ΔC(%) | ΔC(%) | ΔC(%) |
| −55 | −13.15 | −15.87 | −17.62 |
| −25 | −6.83 | −9.36 | −8.67 |
| 0 | −1.37 | −3.12 | −2.34 |
| 25 | 0 | 0 | 0 |
| 85 | −15.38 | −17.32 | −19.17 |
| 105 | −21.7 | −25.49 | −26.95 |

In order to satisfy the X6S temperature characteristics, the capacitance change rate (%) from −55° C. to 105° C. may need to be +22% or less.

Referring to Tables 1 and 2, it can be confirmed that Test No. 1, in which Dy+Tb+Gd is 1.5 mol, satisfies the X6S temperature characteristics, whereas Test Nos. 2 and 3, in which Dy+Tb+Gd is greater than 1.5 mol, fail to satisfy the X6S temperature characteristics.

TABLE 3

| Test No. | Dy | Tb | Gd | Dy + Tb + Gd | Gd/(Dy + Tb) |
|---|---|---|---|---|---|
| 4* | 0.75 | 0.5 | 0.2 | 1.45 | 0.160 |
| 5 | 0.67 | 0.3 | 0.48 | 1.45 | 0.495 |
| 6* | 0.48 | 0.3 | 0.67 | 1.45 | 0.859 |

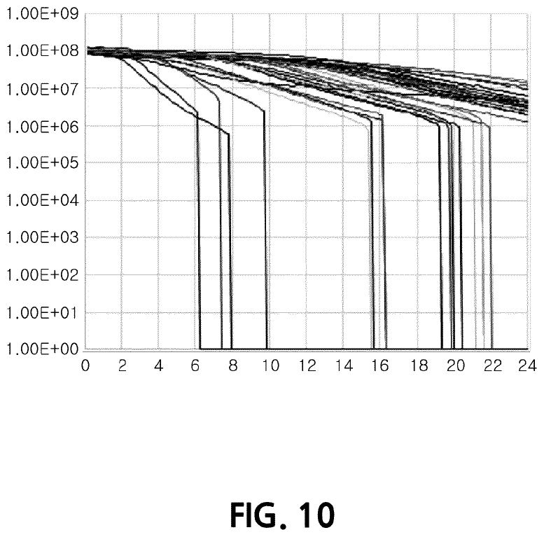

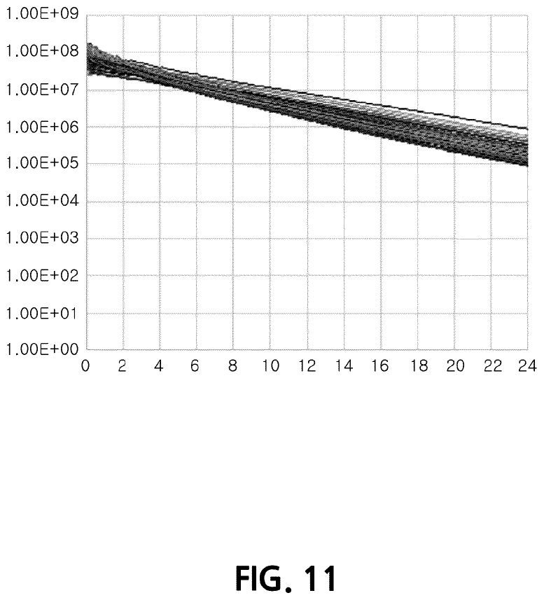

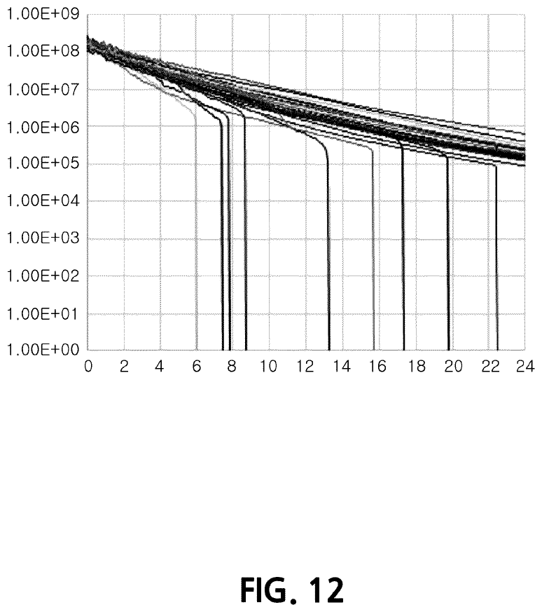

FIGS. 10, 11, and 12 are graphs illustrating results of a highly accelerated life test (HALT) performed on 40 sample chips of each of Test Nos. 4, 5, and 6, respectively. In FIGS. 10 to 12, an X-axis may represent time in units of hours (hr), and a Y-axis may represent insulation resistance (IR) in units of ohms (Ω).

The HALT was performed for 24 hours under a temperature condition of 125° C. and a voltage condition of 1.5 Vr. A sample chip was evaluated as defective when a short circuit occurred in the insulation resistance (IR).

It can be confirmed that Test No. 5, in which a molar ratio of Gd to a sum of Dy and Tb is 0.2 or more and 0.67 or less, exhibits excellent high-temperature lifespan characteristics. Conversely, Test Nos. 4 and 6, in which a molar ratio of Gd to a sum of Dy and Tb is less than 0.2 and greater than 0.67, respectively, exhibit inferior high-temperature lifespan characteristics.

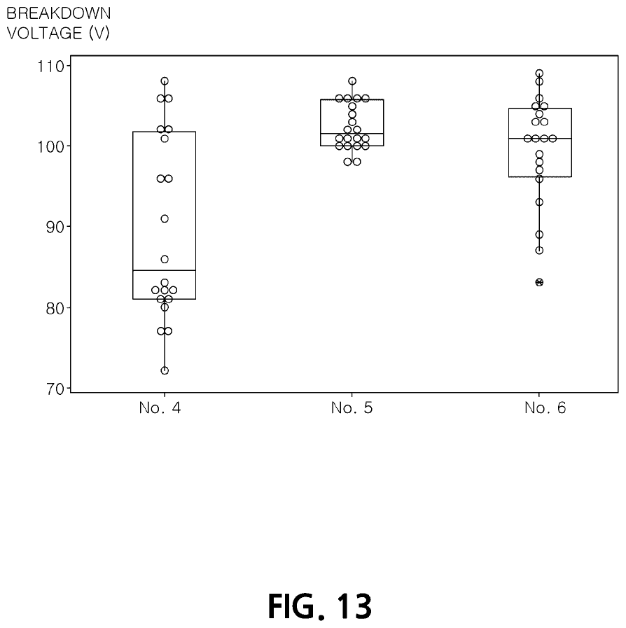

FIG. 13 is a graph illustrating results of measuring breakdown voltages (BDV) of 20 sample chips of each of Test Nos. 4, 5, and 6.

For the breakdown voltage measurement, 20 sample chips were prepared for each test number. A voltage was increased at a rate of 50 V/sec at 25° C., and the voltage at which a short circuit occurred in each sample chip was defined as a BDV and illustrated in FIG. 13.

It can be confirmed that Test No. 5, in which a molar ratio of Gd to a sum of Dy and Tb is 0.2 or more and 0.67 or less, exhibits improved average BDV and variation, as compared to Test Nos. 4 and 6, in which a molar ratio of Gd to a sum of Dy and Tb is less than 0.2 and greater than 0.67, respectively.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein are for the purpose of describing particular example embodiments only and are to not be limiting of the example embodiments. As used herein, the singular forms “a,” “an,” and “the” are intended to include the plural forms as well, unless the context clearly indicates otherwise.

What is claimed is:

1. A multilayer electronic component comprising:
a body including a dielectric layer and internal electrodes alternately disposed with the dielectric layer; and
an external electrode disposed on the body;
wherein the dielectric layer includes a central portion spaced apart from adjacent internal electrodes among the internal electrodes, and an interface portion disposed between the central portion and an internal electrode among the adjacent internal electrodes, the interface portion including Dy, Tb, and Gd, and
the central portion has a Tb content, in atomic percentage, that is lower than a Tb content, in atomic percentage, of the interface portion, or
the central portion is substantially free of Tb.

2. The multilayer electronic component of claim 1, wherein the dielectric layer has a sum of Dy, Tb, and Gd contents of 1.5 mol or less relative to 100 mol of Ti.

3. The multilayer electronic component of claim 1, wherein the dielectric layer has a Tb content of 0.5 mol or less relative to 100 mol of Ti.

4. The multilayer electronic component of claim 1, wherein the dielectric layer has a molar ratio of a Gd content to a sum of Dy and Tb contents of 0.2 or more and 0.67 or less.

5. The multilayer electronic component of claim 1, wherein
the dielectric layer has a Tb content of 0.5 mol or less relative to 100 mol of Ti,
the dielectric layer has a sum of Dy, Tb, and Gd contents of 1.5 mol or less relative to 100 mol of Ti, and
the dielectric layer has a molar ratio of a Gd content to a sum of Dy and Tb contents of 0.2 or more and 0.67 or less.

6. The multilayer electronic component of claim 1, wherein, when the Tb content of the interface portion is referred to as At1 and the Tb content of the central portion is referred to as At2, At1/At2 is 5 or more.

7. The multilayer electronic component of claim 1, wherein, when the Tb content of the interface portion is referred to as At1 and the Tb content of the central portion is referred to as At2, At1 is 0.2 at % or more and 0.5 at % or less, and At2 is 0.1 at % or less.

8. The multilayer electronic component of claim 1, wherein an average thickness of the interface portion is 5 nm or more and 50 nm or less.

9. The multilayer electronic component of claim 1, wherein an average thickness of the central portion is 500 nm or less.

10. The multilayer electronic component of claim 1, wherein, when an average thickness of the central portion is referred to as td and an average thickness of the interface portion is referred to as tcl, tcl/td is 0.02 or more and 0.1 or less.

11. The multilayer electronic component of claim 1, wherein the dielectric layer includes at least one selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), as a main element.

12. The multilayer electronic component of claim 1, wherein
the dielectric layer and the internal electrodes are alternately disposed in a first direction,
the body has first and second surfaces opposing each other in the first direction, third and fourth surfaces connected to the first and second surfaces, the third and fourth surfaces opposing each other in a second direction, and fifth and sixth surfaces connected to the first through fourth surfaces, the fifth and sixth surfaces opposing each other in a third direction, and
the external electrode is disposed on the third and fourth surfaces, and
the multilayer electronic component further comprising a side margin portion disposed on the fifth and sixth surfaces.

13. The multilayer electronic component of claim 12, wherein
the interface portion and the central portion extends to the third and fourth surfaces and are connected to the external electrode, and
the interface portion and the central portion extends to the fifth and sixth surfaces and are connected to the side margin portion.

14. A method of manufacturing a multilayer electronic component, comprising:
coating a sol solution on a film to form a first coating layer, the sol solution including Tb, Dy, and Gd,
coating a slurry on the first coating layer to form a ceramic portion, the slurry including ceramic powder particles,
coating the sol solution on the ceramic portion to form a second coating layer, and
applying a paste to the second coating layer to form a ceramic green sheet, the paste including metal powder particles.

15. The method of claim 14, wherein the slurry is substantially free of Tb, Dy, and Gd.

16. The method of claim 14, further comprising sintering the ceramic green sheet.
